(19) United States
(12) Patent Application Publication
(10) Pub. No.: US 2026/0042240 A1
(43) Pub. Date: Feb. 12, 2026

(54) METHOD AND APPARATUS FOR PRODUCTION OF PALLET BLOCKS

(71) Applicants: Ferenc KECSKEMÉTI, SZOLNOK (HU); Péter BALLA, MARTFU (HU)

(72) Inventors: Ferenc KECSKEMÉTI, SZOLNOK (HU); Péter BALLA, MARTFU (HU)

(21) Appl. No.: 19/102,975

(22) PCT Filed: Aug. 15, 2023
(86) PCT No.: PCT/HU2023/050050

§ 371 Date: Feb. 11, 2025

(30) Foreign Application Priority Data
Aug. 15, 2022 (HU) P2200329

(51) Int. Cl. B27N 3/20; B27N 3/00; B27N 3/22

(52) U.S. Cl. CPC B27N 3/203; B27N 3/007; B27N 3/22

(57) ABSTRACT

Wood scrap and binder components forming raw material (1) of a pallet block are prepared in accordance with predetermined mechanical properties of the pallet block to be produced with a mass equal to the predetermined mass of the finished pallet block. The prepared components are mixed and fed into a press mould (3) of a press die (2), pressed to size, and the binder is cross-linked applying heat externally by the aid of the side walls (11) of the press mould (3) and at the same time internally by applying heat to the central region of the pallet base material (1) via a central forming mandrel (14) conducting hot steam into the pressed the pallet block, thereby promoting the cross-linking of the pallet base material's binder in short time. The invention also relates to an apparatus implementing the method.

The invention relates to a method for the production of pallet blocks, during which the wood scrap and binder components of the pallet block are prepared in accordance with the predetermined mechanical properties of the pallet block to be produced, then the prepared ingredients are mixed and fed into the press mould of a press die as a pallet block raw material, then the pallet block raw material fed into the press box of the press die is pressed to size and the binder is cross-linked using heat, then the pallet block pressed to size and forming a single piece by the cross-linked binder is removed from the press mould of the press die.

The invention also relates to an apparatus for preparing of a pallet block using the proposed method, comprising a feeding device that delivers pallet block raw material into the press mould of a press die, a press die that presses the pallet block material fed into the press mould of the press die, a heating element associated with the press mould and heating the pressed pallet block material fed into the press mould, and pusher means for removal the completed pallet block from the press mould.

An EPAL-type pallet is a loading board of the same size as the EUR-type pallet, the production and repair of which is supervised by the European Pallet Association (EPAL). UIC/EUR, EPAL/EPAL and EPAL/EUR pallets are interchangeable in all European countries. The specifications for pallets, which can be said to be widespread in Europe, can be found in the UIC 435-2 standard: the wood used as the base material for euro-type pallets can be poplar, pine, birch, alder, and hardwood species, pallet blocks, in other words, legs, can be made as pressed blocks or of wood. Thanks to the pressed blocks, the drying time of the pallets is significantly shorter, which reduces the associated drying costs, which is why pressed blocks are increasingly used for pallets. The production of a pallet block (also known as pallet stool) basically requires two components, mixed to an appropriate degree: wood chips and resin. By wood chips both sawdust and wood shavings are meant, the resin is often melamine-containing urea-formaldehyde resin, which begins to cross-link under the influence of heat. However, during the production of a pallet, the resin cross-linking that takes place during the pressing of the pallet block significantly and disadvantageously increases the production time of the pallet.

According to a known method resin is introduced from the outside into the pressed product by the aid of steam. This is not advantageous in the case of pallet blocks, because semi-finished products produced in this way, especially rod products, always require post-processing, they should be cut to size by sawing. There is also a known solution where the product is manufactured in a press mold, so there is no need to saw it, since several blocks can be pressed out of one mold at the same time, but the dosage is based on volume.

HU 231225 describes a process for the production of pallet blocks. The document, the relevant content of which is referred to as a reference, thoroughly explores the state of the art and the shortcomings of known pallet block production processes. During the presented method, a sawdust mixture containing 20-80% poplar grass dust and 80-20% pine sawdust is prepared; the sawdust mixture is dried with air at 400-500° C. to a maximum moisture content of 6%; a raw block material is mixed from the dried sawdust mixture, polycondensation resin and curing liquid, which is filled into a forming mold, then pressed and polymerized in the mold to make a semi-finished block product; then the semi-finished block product is taken out of the mold and chopped to the size of a finished pallet block product. The aim and result of the proposed solution is to use poplar wood with a similar moisture content to form a composite that meets EPAL's soaking and nailing requirements, but it does not provide a solution to speed up the outlined time-consuming curing process.

A production process has been aimed that can eliminate the shortcomings outlined above: no cutting is required, and there is no volume dosing but precisely measured unit dosing. In this way, it is possible to ensure that scrap, i.e., a product of inadequate density is not produced. In any case, production of bars is associated with such serious technological challenges as the subsequent inspection of the final product, and based on its results, modification of inputs by incorporating feedback processes. In such a system, production of scrap is inevitable and can only be reduced by very high-quality feedback. Volume dosing does not allow raw materials of different densities to be applied or fed into the press at will, since the density of the final product changes accordingly, which also means limitations.

The aim of the invention is to significantly shorten the production time of pallet blocks while maintaining high quality of the pallet blocks. Our goal is also to reduce the production losses of the raw materials used, as well as reducing work phases of the production.

Based on the above experiences we came to this realization that stable, scrap-free production can be achieved only by pressing a raw material with an accurately measured mass in advance. However, this is only economical if the curing time of the resin in the product can be shortened to such an extent that an apparatus with economies of scale can be built.

The invention is based on the realization that a pallet block can be produced without material loss, in accordance with the strict dimensional specifications, in a significantly shorter time, if batching is done by density rather than by volume, and by providing a more uniform volume heat effect in the pressed raw material for the curing of the resin. During our attempts with traditional methods, it was not possible to achieve homogeneous cross-linking of the resin in a suitable time, a very long time was needed for bonding if we only applied heat to the pressed material from the outside. The possibility provided by the relevant standard that a hole can also be made in the middle of the product, i.e., the pallet block, gave us the idea that this disadvantage can be reduced if heat is introduced into the pressed product through the hole. For this purpose, the forming mandrel of the hole can be advantageously used, because with its appropriate design, it is possible to immediately introduce a large amount of heat to the inside of the product.

The set goal has been achieved with a method according to claim 1 and an apparatus for implementing the method according to claim 5. Several advantageous implementations of the invention are disclosed in dependent claims.

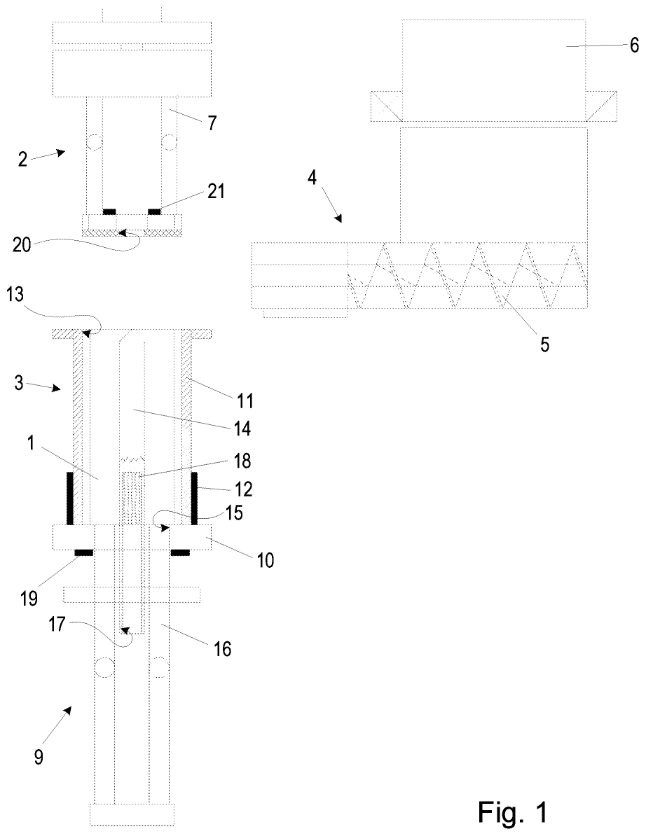

The invention is described below in more detail in connection with an exemplary implementation of the method and an exemplary embodiment of the equipment, with reference to the attached drawing, wherein FIG. 1 schematically shows a possible implementation of the apparatus according to the invention and the operation that implements the method according to the invention.

The initial concept was to manufacture the product one by one, as this avoids cutting waste, which means a material saving of approx. 8%. An exemplary way of implementing the proposed method is presented with the help of the block scheme shown in FIG. 1. During the production of a pallet block, wood scrap and binder components of a pallet block are prepared according to predefined mechanical properties of the pallet block to be produced. One of the advantages of the method is that its application is not limited by the type and nature of the wood scrap used, i.e., whether it is bark, sawdust, waste wood, etc., as well as, for example, by its flexibility or adhesive friction. It is an essential measure to determine the density of the wood scrap to be used by the help of a measuring unit arranged upstream of the feeder 4 in the processing direction of the pallet block raw material 1. In the shown embodiment this is a scale with a high accuracy, for example ±2%, in order to be able to carry out the further steps. Any resin commonly used in the field for this purpose can be used as a binder; no other component is used in the example presented. In a next step the ingredients are mixed to obtain raw material 1. There is a clear and permanent relationship between the final shape and exact size of the pallet block to be produced and the weight of the pallet block raw material 1 used for it. Therefore, in order to obtain a finished product that does not require any further processing steps after the pallet block is pressed, raw material 1 having a same initial mass as the finished product after the production of the pallet block must be fed into a press mould 3 of a press die 2. In the presented example, this is solved by using a screw feeder 4 with a structure and function known to a person skilled in the art to deliver the raw material 1 to the press mould 3, which is located and operates horizontally, i.e., an auger 5 of the screw feeder 4 rotates along a horizontal axis and ensures advancing of the supplied raw material 1. The longitudinal axis of the feeder 4 runs perpendicular to the longitudinal axis of a press head 7 and press mould 3 of the press die 2, intersecting said longitudinal axis. The feeder 4 is arranged adjacent to the press mould 3 and can be moved in its longitudinal direction above the press mould 3.

The horizontal arrangement of the feeder 4 according to the example is only one possibility, the feeder 4 can be arranged at an angle relative to the press die 2, or it can be arranged by ensuring that the position of the feeder 4 does not affect the amount of raw material 1 delivered. Another feature of the feeder 4 is that it can be moved back and forth along its longitudinal axis, i.e., in the horizontal position in the present example, “forward” means the direction in which the raw material 1 exits the feeder 4. The precise measurement of the raw material 1 is carried out with a measuring unit comprising a digital dosing scale 6 installed above an auger 5 of the feeder 4, whose lower outlet, which can be opened and closed in a controllable way, is located above the auger 5 of the feeder 4, and from which the exact amount of raw material 1 falls into the space of the auger 5 of the feeder 4 without residue. The complete movement of the raw material 1 is ensured by the appropriate choice of materials for the parts of the device that come into contact with the raw material 1, namely the parts of the dosing scale 6 and the feeder 4, for example using stainless steel as known for a person skilled in the art.

The press die 2 illustrated in FIG. 1 is a vertical operated tool, i.e., a press head 7 of the press die 2 is vertically movable above the press mould 3, and a pusher means 9 comprising a vertically movable pusher element is arranged below the press mould 3. Metal side walls 11 forming the vertical sides of the pallet block to be produced is connected to a base plate 10 of the press mould 3, where the lower third of said metal side walls 11 is used in this example as an external heating element of a heating means of known structure and operation and is surrounded by a heating jacket 12 that transfers the heat to the metal side wall 11, causing cross-linking of the resin. Heat can be generated in a manner known and customary in the field, in the present example the heating jacket 12 comprises electric heating that ensures a constant temperature. The upper side of the press mould 3 is open and designed as an opening 13 for loading of the raw material 1, outputting the manufactured pallet block 1 and is designed for receiving the press head 7 of the press die 2 and surrounding it in a form-fit manner. A forming mandrel 14 extending vertically upwards to the opening 13 of the press mould 3 is fixed centrally on the base plate 10 of the press mould 3, which forms during the production of the pallet block a central hole, often found in pallet blocks, and which also serves as a heating pipe according to the invention. In the base plate 10 of the press mould 3, an opening 15 is formed centrally and concentrically with the forming mandrel 14, surrounding a piston 16 in a form-fit manner, forming the pushing element of the pusher means 9 that removes the finished pallet block from the press mould 3. The forming mandrel 14 is a hollow element and is connected to a heating pipe, in the shown embodiment a steam pipe 17 connected to the press mould 3 inside the piston 16 of the product pusher means 9. The steam pipe 17 is connected to a steam source that produces steam at a temperature that allows the resin to cross-link, which is not shown separately in the drawing for the sake of clarity, however, the implementation and operation of which can be considered a routine activity for a person skilled in the art. The cylindrical shell of the molding mandrel 14, forming a channel and which is essentially the same height as the height of the already pressed pallet block inside the press mould 3, is provided with perforations 18, through which the steam guided through the steam pipe 17 into the inner cavity of the molding mandrel 14 can be introduced into the already pressed material 1 in the press mould 3 by overpressure, and intensively promotes rapid and homogeneous cross-linking of the resin in it. The latter was confirmed unanimously by the examination of pallet block sections produced in this way. Discharge of the excess part of the introduced high-pressure steam from the press mould 3 is ensured by a peripheral steam discharge ring 19 of the opening 15 of the base plate 10, connected to the steam pipe 17 and made of vapor-permeable material, as well as a peripheral steam removal ring 21 made of vapor-permeable material of a central opening 20 of the press head 7, allowing the forming mandrel 14 to pass through during pressing.

After introducing the raw material 1 of controlled mass of into the feeder 4, the latter will be moved forward horizontally until its front end reaches above the opening 13 of the press mould 3, and the raw material 1 will be fed with the auger 5 into the press mould 3 without residue, then the feeder 4 will be pulled back to its rear position. The raw material 1 fed into the press mould 3 of the press die 2 will then be pressed to exact size, and the resin used as a binder will be cured using heat. In doing so, as an essential measure of the invention, the raw material 1 will be heated from the inside with the heat supplied to the central region of the raw material 1 fed into the press mould 3 of the press die 2, or more precisely with steam supplied to the raw material 1 through the forming mandrel 14 and, for example, a known controllable valve and the perforation 18, the curing of the binder will be promoted. After the end of the cross-linking, the typical time of which is in a range of 2.5-3-5 minutes according to preliminary experiments, the press head 7 will be lifted and removed from the press mould 3, and the pallet block pressed to size and formed a single, uniform piece by the cross-linked binder, will be moved upwards by the piston 16 of the pusher element of the pusher means 9 by from the press mould 3 of the press die 2 through its opening 13, then the pallet block already leaving the press mould 3 and resting on the pusher element will be removed by repeatedly moving the feeder 4 in forward direction, moving the pallet block out of the working range of the press die 2. Then the pallet block will be collected in some known way and stored before being transported, since no further operations shall be performed. After that or at the same time, the pusher element is moved to its lower end position, thereby providing space for the introduction of the next dose of raw material 1.

The presented operation can be repeated cyclically.

It can be seen that an essential element of the apparatus according to the invention is the digital dosing scale 6, which ensures that the density of the raw material 1 is set in advance, thanks to which each finished product will have the same weight, and since the volume is fixed by the referenced standard, it will also have the same density. With the dosing scale 6, the previously mixed raw material 1—a mixture of wood chips and resin—is measured one by one in accordance with the prescribed standard and fed into the press mould 3 via the feeder 4. The referenced standard specifies the minimum number of kilograms per cubic meter of product. With the digital dosing scale 6 this can be ensured in advance, there is no need to integrate complicated post-checking processes into the production system.

Another important element is the forming mandrel 14, which forms a standard-sized hole in the center of the produced pallet block, and which, due to its design, is also suitable for introducing heat into the interior of the product through it, where the heat is introduced by steam injection. The press mould 3 is heated from the outside, so the product receives heat from both the outside and the inside. As a result of the steam injected after pressing, the resin forms a homogeneous cross-section in the entire cross-section of the product, namely in less than three minutes. Without such steaming, curing takes even more than an hour, as the heat to be introduced into the interior of the product by the heating jackets 12 arranged on the sides of the press mould 3 reaches the interior very slowly due to the thermal insulation property of the wood, thus the internal temperature required for curing, which is approx. 130° C., is difficult to reach. With the steam introduced through the perforated lower part, which ensures a homogeneous inflow of steam into the product, this temperature is immediately reached, while the external heating ensures that this heat is not lost but remains constant during curing.

It is important that the press mould 3 is designed in such a way that it is suitable for receiving one unit of raw material 1 measured by the dosing scale 6. The raw material 1 will be put around the inner forming mandrel 14 in the press mould 3 with the help of the auger 5 of the feeder 4, and after filling, the product will be created by moving the press head 7 downwards. The press head 7 keeps the product under pressure until it is finished, i.e., until the curing is completed. After curing, the press head 7 will be moved upwards, providing space until the product is removed from the press mould 3, which is realized by the upward movement of the lower pushing means 9.

Among the main advantages of the method and apparatus according to the invention, it can be highlighted that it is possible to produce a product of the same size and density in a short time: with the help of the invention, the curing process is usually shortened to less than 3 minutes. The production became independent of the quality of the wood scrap used—type of wood, type of wood scrap: bark, sawdust, waste wood, etc.—its flexibility and adhesive friction. With steaming, it is also possible to achieve that, in addition to the addition of resin, no other ingredients such as hardener (acid) or emulsion (slipper) are needed. After the product is finished, it does not require further treatment, i.e., cutting to size, but after a short rest period corresponding to the cooling time, a packable product is created. By using steaming, not only the setting time can be reduced but also much safer curing process and better quality can be achieved than in the case of external heating alone.

### LIST OF REFERENCE MARKS

1 raw material
2 press die
3 press mould
4 feeder
5 auger
6 dosing scale
7 press head
9 pusher means
10 base plate
11 side wall
12 heating jacket
13 opening
14 forming mandrel
15 opening
16 piston
17 steam pipe
18 perforation
19 steam discharge ring
20 opening
21 steam removal ring

1. A method for the production of pallet blocks, comprising
preparing wood scrap and binder components of raw material (1) of the pallet block according to predetermined mechanical properties of the pallet block to be produced,
mixing the prepared ingredients and feeding the mixed ingredients as a raw material (1) for a pallet block into a press mould (3) of a press die (2),
pressing the raw material (1) of the pallet block fed into the press mould (3) of the press die (2) to size, then curing binder using heat,
removing the pallet block pressed to size and formed as a single piece due to the cross-linked binder from the press mould (3) of the press die (2),
characterized by the further steps of
during the preparation of the components of the pallet block, determining the density of the wood debris component of the pallet block to be produced,
feeding the wood scrap and binder components into the press mould (3) of the press die (2) as a pallet block raw material (1) with a mass equal to the pre-determined, finished mass of the pallet block to be produced,
during the curing the binder of the pallet block material (1), heating the pressed pallet block raw material (1) also from its inside with heat supplied to the press mould (3) of the press die (2) in the central region of the pressed pallet block raw material (1) and thereby promoting crosslinking of the used binder component.

2. The method according to claim 1, wherein during the preparation step the mass of the pallet block raw material (1) to be fed into the press mould (3) of the press die (2) is set to differ by no more than ±2% from the finished mass of the pallet block after production.

3. The method according to claim 1, wherein during the step of curing binder using heat the heat supplied to a center region of the pressed raw material (1) in the press mould (3) of the press die (2) is supplied to the pressed raw material (1) in the form of steam.

4. The method according to claim 3, wherein during the step of curing binder using heat the steam is supplied into the inside of the pressed raw material (1) through a perforated (18) channel extending in the middle of the press mould (3) of the press die (2) and surrounded by the pressed raw material (1) dwelling in the press mould (3) of the press die (2).

5. Apparatus for the implementation of a method according to claim 1 for production of a pallet block, comprising
a feeder (4) for supplying pallet block raw material (1) into a press mould (3) of a press die (2),
a press die (2) for pressing the pallet block raw material (1) fed into the press mould (3) of the press die (2),
heating means associated with the press mould (3) for heating the pressed pallet block raw material (1) fed into the press mould (3) of the press die (2),
pusher means (9) for removing the completed pallet block from the press mould (3),
characterized by further comprising
a measuring unit arranged upstream of the feeder (4) in the processing direction of the pallet block raw material (1) for determining the density of the pallet block raw material (1),
wherein
the upper side of the press mould (3) is designed as an opening (13) for receiving the pallet block raw material (1) and discharging the finished pallet block, designed as an opening (13) that accommodates a press head (7) of the press die (2) and surrounds it in a form-fit manner,
a base plate (10) of the press mould (3) comprises an opening (15) that accommodates a piston (16) of the pusher means (9) for removing the finished pallet from the press mould (3), surrounding the piston (16) in a form-fit manner,
a region of the metal side wall (11) of the press mould (3) is in heat-conducting contact with an external heating element of the heating means,
a heating pipe is introduced into the press mould (3) along a vertical longitudinal axis of the press mould (3),
the heating pipe is equipped with a circumferential perforation (18),
the heating pipe is in a controllable medium connection with a steam source,
the area surrounding the heating pipe of the press mould (3) is designed as a steam discharge ring (19) of vapor wicking material,
the piston (16) of the pusher means (9) that removes the finished pallet block from the press mould (3) is designed to surround said heating pipe.

6. The apparatus according to claim 5, wherein the heating pipe is formed by a forming mandrel (14) extending coaxially to the longitudinal axis of the press mould (3) to an upper side of the press mould (3), and an opening (20) for receiving the forming mandrel (14) is provided in the press head (7) of the press die (2).

7. The apparatus according to claim 6, wherein in the opening (20) in the press head (7) of the press die (2) receiving the forming mandrel (14) a steam removal ring (21) of vapor wicking material is inserted for connection with the introduced forming mandrel (14).

8. The apparatus according to claim 5, wherein
the feeder (4) comprises a screw feeder,
the measuring unit is mounted on the top of the screw feeder separately from it,
the longitudinal axis of the feeder (4) is arranged perpendicular to the longitudinal axis of the press head (7) and press mould (3), intersecting said axis, and
the feeder (4) is arranged adjacent to the press mould (3) and can be moved in its longitudinal direction above the press mould (3).

9. The apparatus according to claim 5, comprising a digital dosing scale (6) as a measuring unit.
